(19) United States
(12) Patent Application Publication
(10) Pub. No.: US 2026/0250102 A1
(43) Pub. Date: Aug. 27, 2026

(54) LIFT DEVICE AND ELEVATOR

(71) Applicant: Inventio AG, Hergiswil (CH)

(72) Inventors: Joe Zhou, Jiading Shanghai (CN); Yinguo Yang, Jiading Shanghai (CN); Tony Chen, Jiading Shanghai (CN); Lucy Lu, Jiading Shanghai (CN); Golson Wu, Jiading Shanghai (CN)

(21) Appl. No.: 18/994,090

(22) PCT Filed: Jul. 20, 2023
(86) PCT No.: PCT/EP2023/070113

§ 371 Date: Jan. 14, 2025

(30) Foreign Application Priority Data
Jul. 21, 2022 (EP) 22186133.9

(51) Int. Cl. B66B 11/00; B66B 9/00; B66B 17/12

(52) U.S. Cl. CPC B66B 11/0045; B66B 9/00; B66B 17/12

(57) ABSTRACT

A lift device for a machine-room-less elevator includes: a car guide rail; a support assembly, wherein a first end of the car guide rail on the same side of the support assembly extends into the support assembly and is connected with the support assembly; and a traction machine arranged on the support assembly, wherein the distance between the traction machine and the first end of the car guide rail is smaller than the height of the support assembly.

### FIELD

The present disclosure relates to the technical field of elevator installation, and in particular, to a lift device and to an elevator.

### BACKGROUND

With a lift device for a machine-room-less elevator, there are generally two arrangements for the traction machine. The first is to arrange the traction machine between the car guide rail and the adjacent hoistway wall; and the second is to arrange the traction machine just above the car guide rail.

For the first arrangement, since the traction machine is located between the car guide rail and the hoistway wall, in order to minimize the size of the cross section of the hoistway, the axial dimension of the traction machine needs to be designed to be very small, so the radial dimension of the traction machine needs to be increased accordingly. If the radial dimension of the traction machine is so large, the operation space of the counterweight needs to be compressed, thereby the height of the counterweight is limited, and a counterweight block with a larger mass needs to be provided, resulting in an increase in the cost of the counterweight.

For the second arrangement, the traction machine and the machine bracket are both arranged above the car guide rail, resulting in a limited height of the car guide rail, and this arrangement will also cause that the distance from the top of the car guide rail to the traction machine is larger than the height of the traction machine bracket, reducing poor operation stability of the traction machine, thereby causing certain potential safety hazards.

### SUMMARY

In view of the existing technical problems, the present disclosure provides a lift device for a machine-room-less elevator, and an elevator as well, which are intended to at least partially solve the above technical problems.

According to one aspect of the present disclosure, there is provided a lift device for a machine-room-less elevator, including: a car guide rail; a support assembly, a first end of the car guide rail extending into the support assembly and being connected to the support assembly; and a traction machine arranged on the support assembly, wherein the distance between the traction machine and the first end of the car guide rail is smaller than the height of the support assembly.

According to an embodiment of the present disclosure, the traction pulley of the traction machine is provided above the car guide rail, and the axial direction of the traction pulley is perpendicular to the hoistway wall adjacent to the car guide rail.

According to an embodiment of the present disclosure, a car is further included, which is slidably matched with the car guide rail, and the orthographic projection of the traction machine in the lift direction of the car partially overlaps with the orthographic projection of the car in the lift direction of the car.

According to an embodiment of the present disclosure, a first vibration damping member is further included, which is arranged on the car guide rail and is located at a lower part of the support assembly.

According to an embodiment of the present disclosure, a fixing member is further included, which is preferably arranged below the first vibration damping member, the fixing member is connected with the car guide rail and the adjacent counterweight guide rail, and is fixed on the side wall of the hoistway wall.

According to an embodiment of the present disclosure, the support assembly includes: a first bracket; and a second bracket mounted below the first bracket; wherein the first end of the car guide rail extends into the second bracket and is connected to the first bracket.

According to an embodiment of the present disclosure, the first bracket and the second bracket have essentially the same height. Height refers to the vertical dimension of the brackets in their installed position within the shaft. This allows the use of the same profile for both the first and the second bracket and thus enables a cost effective lifting device.

According to an embodiment of the present disclosure, the first bracket includes two transverse beams, the two transverse beams are arranged in parallel and spaced apart in a horizontal direction and essentially perpendicular to the side wall of the hoistway wall.

According to an embodiment of the present disclosure, the second bracket includes two longitudinal beams, the two longitudinal beams are arranged in parallel and spaced apart in a horizontal direction and are essentially perpendicular to the first bracket, preferably the transverse beams, and the first end of the car guide rail is located between the transverse beams of the first bracket.

According to an embodiment of the present disclosure, the traction machine is mounted on the two transverse beams; and the two transverse beams are located on both radial sides of the traction pulley of the traction machine.

According to an embodiment of the present disclosure, a car guide rail bracket is arranged between the two transverse beams for being connected with the first end of the car guide rail.

According to an embodiment of the present disclosure, a counterweight assembly is further included, and the counterweight assembly includes: two counterweight guide rails, which are arranged in parallel and spaced apart in a horizontal direction, and the first end of each counterweight guide rail is preferably provided between the longitudinal beams; a counterweight pulley, formed between the two counterweight guide rails; a counterweight support means, formed in a groove circumferentially provided on the counterweight pulley; and a counterweight, arranged below the counterweight pulley and slidably matched with the counterweight guide rail.

According to an embodiment of the present disclosure, the traction pulley of the traction machine is arranged immediately above the counterweight guide rail.

According to an embodiment of the present disclosure, a second vibration damping member is further included, which is arranged on the counterweight guide rail and located at the lower part of the support assembly.

According to an embodiment of the present disclosure, a third vibration damping member is further included, which is arranged between the counterweight guide rail and the adjacent car guide rail, and is provided on the fixing member.

According to an embodiment of the present disclosure, the counterweight pulley is formed at an orthographic projection position below the area formed between the two longitudinal beams.

According to an embodiment of the present disclosure, one end of the counterweight support means is connected to the support assembly, preferably to the second bracket.

According to another aspect of the present disclosure, there is provided a machine-room-less elevator including the above and in the following described lift device.

The traction machine is installed through the support assembly, the support assembly and the traction machine are both formed above the car guide rail, resulting in no need for a flat design of the traction machine, which is beneficial to decrease the design difficulty and manufacturing cost for the traction machine. The ends on the same side of the car guide rail and the support assembly are formed in the support assembly to reduce the distance between the traction machine and the car guide rail, which is beneficial to improve the stability of the elevator operation.

The elevator provided by the present disclosure has the advantages of a machine-room-less lift device for a machine-room-less elevator, and can be relatively stable during the lift movement of the car.

Other purposes and advantages of the present disclosure will be apparent from the following description of the present disclosure with reference to the drawings, and may assist in a comprehensive understanding of the present disclosure.

### DESCRIPTION OF THE DRAWINGS

FIG. 1 schematically shows a schematic structural view of a lift device according to an embodiment of the present disclosure;

FIG. 2 is a top view of the exemplary embodiment shown in FIG. 1; and

FIG. 3 schematically shows a schematic structural view of an elevator according to an embodiment of the present disclosure.

### DETAILED DESCRIPTION

In order to make the purposes, technical solutions and advantages of the embodiments of the present disclosure much clearer, the technical solutions of the embodiments of the present disclosure will be clearly described below with reference to the accompanying drawings of the embodiments of the present disclosure. Obviously, the described embodiments are some of, but not all, the embodiments of the present disclosure. Based on the described embodiments of the present disclosure, all other embodiments obtained by those ordinary skilled in the art without creative work are within the protection scope of the present disclosure.

Unless otherwise defined, technical or scientific terms used in the present disclosure shall have the ordinary meaning as understood by those ordinary skilled in the art. The terms “first”, “second” and similar terms used herein do not denote any order, quantity, or importance, but are merely used to distinguish different components. “Comprising” or “including” and similar words mean that the elements or things appearing before the word encompass the elements or things recited after the word and their equivalents, but do not exclude other elements or things.

In this document, unless specifically stated otherwise, directional terms such as “upper,” “lower,” “left,” “right,” “inner,” “outer,” and the like are used to denote an orientational or positional relationship based on what is shown in the drawings, which is provided for convenience in describing the present disclosure only and are not intended to indicate or imply that the referred device, element or component must have a particular orientation, be constructed or operate in a particular orientation. It should be understood that, when the absolute positions of the described objects change, the relative positional relationship they represent may also change accordingly. Therefore, these directional terms should not be construed as limiting the present disclosure.

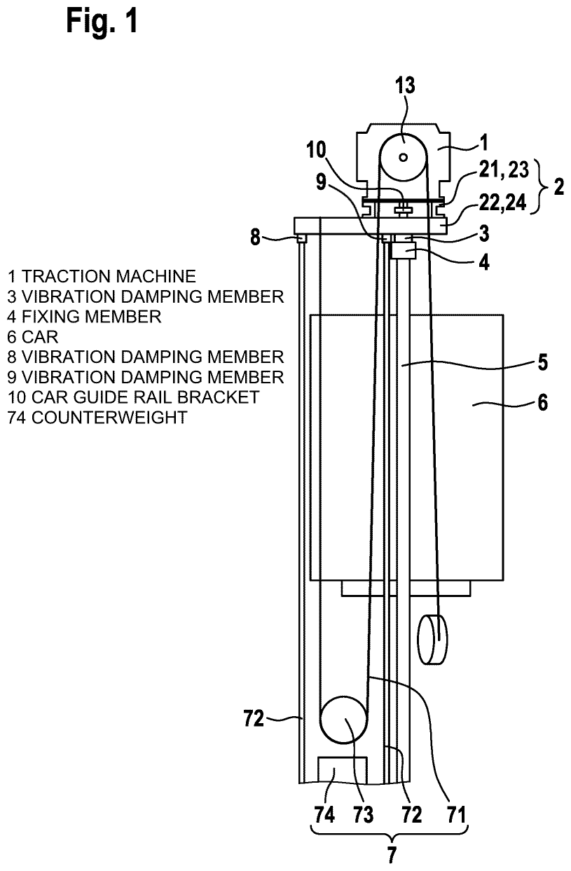

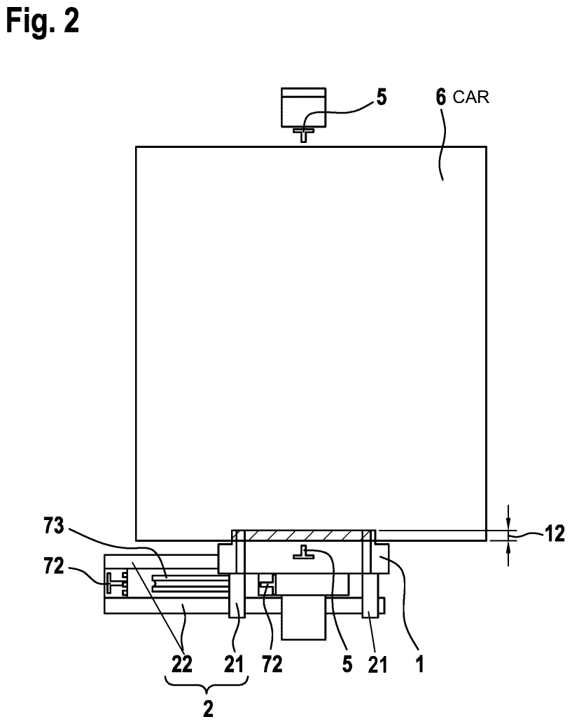

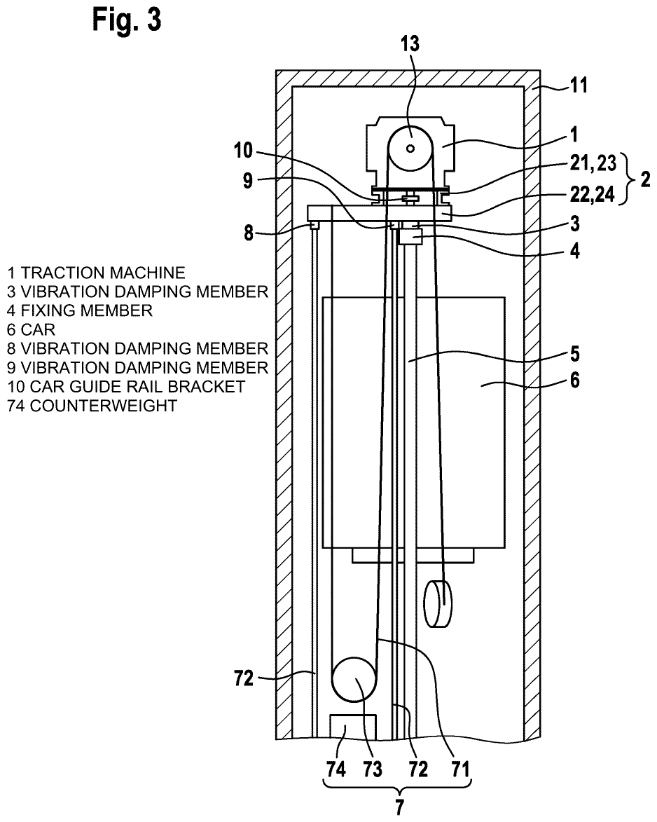

FIG. 1 schematically shows a schematic structural diagram of a lift device for a machine-room-less elevator according to an embodiment of the present disclosure; FIG. 2 is a top view of the exemplary embodiment shown in FIG. 1; FIG. 3 schematically shows a schematic structural diagram of an elevator according to an embodiment of the present disclosure.

One aspect of the present disclosure schematically shows a lift device for a machine-room-less elevator, as shown in FIG. 1 and FIG. 2, including a car guide rail 5 extending in a vertical direction, a support assembly 2 and a traction machine 1. Wherein, the first or upper end of the car guide rail 5 extends into the support assembly 2 and is connected with the support assembly 2; the traction machine 1 is arranged on the support assembly 2, and the distance from the traction machine 1 to the first end of the car guide rail 5 is less than the height of the support assembly 2. The second or lower end of the car guide rail 5 is not shown.

The first end of the car guide rail 5 is characterized by the end of the car guide rail 5 close to the traction machine 2; the height of the support assembly 2 is characterized by the vertical height from the upper surface to the lower surface of the support assembly 2. By adopting the above-mentioned configuration, the distance between the traction pulley 13 and the car guide rail 5 can be effectively reduced, which is beneficial to improve the stability of the running process of the elevator.

Specifically, the distance between the traction machine 1 and the car guide rail 5 is less than 20 mm. It should be understood that the embodiments of the present disclosure are not limited thereto.

For example, the distance between the traction machine 1 and the car guide rail 5 should be reasonably designed according to different elevators and different installation positions of the elevators. The distance between the traction machine 1 and the car guide rail 5 should be as small as possible without increasing the size and structural strength of the traction machine 1.

According to the embodiment of the present disclosure, the axial direction of the traction pulley 13 of the traction machine 1 is perpendicular to the side wall of the hoistway wall 11 (FIG. 3) adjacent to the car guide rail 5.

According to the embodiment of the present disclosure, a car 6 is further included. The car 6 is slidably attached to the car guide rail 5, and an orthographic projection of the traction machine 1 in a lift direction of the car 6 partially overlaps with an orthographic projection of the car 6 in the lift direction of the car 6. Wherein, the partial overlap is characterized by the fact that the orthographic projection of the traction machine 1 and the orthographic projection of the car 6 are not completely contained to each other.

Specifically, the distance of the orthographic projection of the traction machine 1 into the car 6 in the lift direction of the car 6 should be less than 50 mm (see distance 12 in FIG. 2). Such an embodiment can form a larger area above the car 6, which is beneficial to reduce the size of the hoistway for installing the car 6, while not affecting the maintenance space at the top of the car.

According to an embodiment of the present disclosure, the lift device further includes a first vibration damping member 3 provided between the first end of the car guide rail 5 and the support assembly 2. Buffering the car guide rail 5 in the above configuration is beneficial to the distribution of the load applied on the car guide rail 5, so that the counterweight distribution of the car guide rail 5 is optimized, and the use cost of the car guide rail 5 is reduced.

Specifically, the first vibration damping member 3 includes a vibration damping block made of rubber material. It should be understood that the embodiments of the present disclosure are not limited thereto.

Further, either direct installation or indirect installation may be adopted for the first vibration damping member 3 and the car guide rail 5. Among them, the direct (immediate) installation is characterized by the direct contact between the first damping member 3 and the car guide rail 5 to form an assembly; and the indirect installation is characterized by the first vibration damping member 3 being installed on the components assembled on the car guide rail 5 (such as the car guide rail bracket 10 and other structural components connected to the car guide rail 5).

According to an embodiment of the present disclosure, the support assembly 2 includes a first bracket 23 and a second bracket 24 mounted below the first bracket 23, wherein the first end of the car guide rail 5 extends into the second bracket 24.

According to an embodiment of the present disclosure, the first bracket 23 includes two transverse beams 21 which are arranged in parallel and spaced apart in the horizontal direction and are perpendicular to the hoistway wall.

According to an embodiment of the present disclosure, the second bracket 24 includes two longitudinal beams 22 arranged in parallel and spaced apart in the horizontal direction and perpendicular to the transverse beams 21, and the first end of the car guide rail 5 is located between the transverse beams 21.

Specifically, the rectangular area formed in the middle part between the two beams 21 serves as the above-mentioned installation space. It should be understood that embodiments of the present disclosure are not limited thereto.

For example, the support assembly 2 can also be formed with an annular, a polygonal installation space and the like which forms a hollow area in a plane.

Further, the installation space can also use a non-hollow area. For example, the installation space adopts a bowl-shaped structure, and the above-mentioned installation space and the surface on the same side of the car guide rail 5 form a groove, and the first end of the car guide rail 5 is fixed in the groove.

According to an embodiment of the present disclosure, the traction machine 1 is installed on the upper surfaces of the two transverse beams 21.

According to an embodiment of the present disclosure, two transverse beams 21 are assembled to the traction machine 1. Wherein, the two transverse beams 21 are formed on both radial sides of the traction pulley 13 of the traction machine 1. The above-mentioned configuration is beneficial to improve the stability of the assembly of the support assembly 2 and the traction machine 1, so that the load applied on the support assembly 2 is relatively uniform.

Specifically, the two transverse beams 21 are arranged symmetrically about the axial direction of the center of the traction pulley 13. It should be understood that embodiments of the present disclosure are not limited thereto.

For example, the two transverse beams 21 can also form an asymmetrical assembly form with the traction machine 1 through other components (such as hoop, screw fit or counterweight) on the basis of ensuring the stable installation of the traction machine 1.

According to an embodiment of the present disclosure, a car guide rail bracket 10 for being connected with the first end of the car guide rail 5 is arranged between the two transverse beams 21.

According to an embodiment of the present disclosure, the lift device further includes a counterweight assembly 7, the counterweight assembly 7 includes two counterweight guide rails 72 arranged in parallel and spaced apart in the horizontal direction; a counterweight pulley 73 arranged between the two counterweight guide rails 72; a counterweight support means 71 encircling in a groove circumferentially provided on the counterweight pulley 73; and a counterweight 74 arranged below the counterweight pulley 73 and slidably matched with the counterweight guide rail 72. Wherein, the first or upper end of each counterweight guide rail 72 is arranged between the two longitudinal beams 22.

Specifically, the two counterweight guide rails 72 are parallel to the car guide rails 5, and the two counterweight guide rails 72 are both provided below the two longitudinal beams 22.

According to the embodiment of the present disclosure, a second vibration damping member 8 is further included, which is arranged between the upper part of the counterweight guide rail 72 and the lower part of the support assembly 2.

According to the embodiment of the present disclosure, a third vibration damping member 9 is further included, which is provided between the counterweight guide rail 72 and the adjacent car guide rail 5. The arrangement of the second vibration damping member 8 and the third vibration damping member 9 is beneficial to isolating the vibration generated during the elevator operation from the hoistway wall, which can effectively improve the comfortability of the elevator operation.

Specifically, the second vibration damping member 8 and the third vibration damping member 9 include vibration damping blocks made of rubber material. It should be understood that the embodiments of the present disclosure are not limited thereto.

According to an embodiment of the present disclosure, a fixing member 4 is further included, which is preferably arranged below the first vibration damping member 3, the fixing member 4 is connected with the car guide rail 5 and the adjacent counterweight guide rail 72, and is fixed on the side wall of the hoistway wall 11. The third vibration damping member 9 is arranged between the counterweight guide rail 72 and the adjacent car guide rail 5, and is provided on the fixing member 4.

According to an embodiment of the present disclosure, the counterweight pulley 73 is formed at an orthographic projection position below the area formed between the two longitudinal beams 22. In such a configuration, when the counterweight pulley 73 is located at the highest position of the hoistway, the space between the two longitudinal beams 22 is accessible, thereby being beneficial to reduce the influence of the traction machine 1 and the counterweight space, and the counterweight 74 can be made of several counterweight blocks, which is beneficial to reduce the cost of the counterweight.

According to an embodiment of the present disclosure, one end of the counterweight support means 71 is connected to the support assembly 2.

According to another aspect of the present disclosure, a machine-room-less elevator is further provided, as shown in FIG. 3, including a lift device as described above and in the following.

Specifically, the lift device for the machine-room-less elevator is inside the hoistway wall 11.

Although some embodiments according to the general technical concept of the present disclosure have been shown and described, those ordinary skilled in the art will understand that changes may be made to these embodiments without departing from the principles and spirit of the general technical concept of the present disclosure, the scope of the invention is defined by the claims and their equivalents.

In accordance with the provisions of the patent statutes, the present invention has been described in what is considered to represent its preferred embodiment. However, it should be noted that the invention can be practiced otherwise than as specifically illustrated and described without departing from its spirit or scope.

1-15. (canceled)

16. A lift device for a machine-room-less elevator, the lift device comprising:
a car guide rail extending in a vertical direction and having an upper end;
a support assembly, the upper end of the car guide rail extending into and being connected with the support assembly; and
a traction machine arranged on the support assembly, wherein a distance between the traction machine and the upper end of the car guide rail is less than a height of the support assembly in the vertical direction.

17. The lift device according to claim 16 wherein an axial direction of a traction pulley of the traction machine extends perpendicular to a hoistway wall extending in the vertical direction adjacent to the car guide rail.

18. The lift device according to claim 16 including a car slidably matched with the car guide rail, wherein an orthographic projection of the traction machine in the vertical direction partially overlaps with an orthographic projection of the car in the vertical direction.

19. The lift device according to claim 16 including a vibration damping member arranged on the car guide rail and located at a lower part of the support assembly.

20. The lift device according to claim 19 including a fixing member connected with the car guide rail and with an adjacent counterweight guide rail, the fixing member being on a side wall of a hoistway wall that extends in the vertical direction.

21. The lift device according to claim 20 wherein the fixing member is arranged below the vibration damping member.

22. The lift device according to claim 16 wherein the support assembly comprises:
a first bracket;
a second bracket arranged below the first bracket; and
wherein the upper end of the car guide rail extends into the first bracket and the first bracket and the second bracket have a same height.

23. The lift device according to claim 22 wherein the first bracket includes two transverse beams arranged in parallel and spaced apart in a horizontal direction, the transverse beams extending perpendicular to a side wall of a hoistway wall that extends in the vertical direction.

24. The lift device according to claim 23 wherein the second bracket includes two longitudinal beams arranged in parallel and spaced apart in a horizontal direction, the longitudinal beams extending perpendicular to the first bracket, and the upper end of the car guide rail is attached to the first bracket.

25. The lift device according to claim 23 wherein the traction machine is mounted on the transverse beams and the transverse beams are positioned on opposite radial sides of a traction pulley of the traction machine.

26. The lift device according to claim 23 including a car guide rail bracket arranged between the transverse beams and being connected with the upper end of the car guide rail.

27. The lift device according to claim 16 including a counterweight assembly, the counterweight assembly comprising:
two counterweight guide rails arranged in parallel and spaced apart in the vertical direction, an upper end of each of the counterweight guide rails extending into and being attached to the support assembly;
a counterweight pulley arranged between the counterweight guide rails;
a counterweight support means formed in a circumferential groove on the counterweight pulley; and
a counterweight arranged below the counterweight pulley and slidably matched with the counterweight guide rails.

28. The lift device according to claim 27 including a vibration damping member arranged on the upper end of one of the counterweight guide rails and being attached to the support assembly.

29. The lift device according to claim 28 including a first vibration damping member arranged on the upper end of the car guide rail and attached to the support assembly, wherein the vibration damping member is a second vibration damping member, and including a third vibration damping member arranged on the upper end of another of the counterweight guide rails and being attached to the support assembly.

30. The lift device according to claim 29 wherein a traction pulley of the traction machine is arranged immediately above the upper end of the another counterweight guide rail.

31. The lift device according to claim 30 wherein an end of the counterweight support means is connected to the support assembly.

32. A machine-room-less elevator comprising:
a hoistway wall;
the lift device according to claim 16 installed adjacent to the hoistway wall; and
a car slidably matched with the car guide rail.

33. A lift device for a machine-room-less elevator, the lift device comprising:
a car guide rail extending in a vertical direction and having an upper end;
a support assembly, the upper end of the car guide rail extending into and being connected with the support assembly;
a traction machine arranged on the support assembly, wherein a distance between the traction machine and the upper end of the car guide rail is less than a height of the support assembly in the vertical direction;
a first vibration damping member arranged on the car guide rail and located at a lower part of the support assembly;
two counterweight guide rails arranged in parallel and spaced apart in the vertical direction, an upper end of each of the counterweight guide rails extending into and being attached to the support assembly;
a second vibration damping member arranged on the upper end of one of the counterweight guide rails and being attached to the support assembly;
a third vibration damping member arranged on the upper end of another of the counterweight guide rails and being attached to the support assembly; and
a fixing member connected with the car guide rail and with the another counterweight guide rail, the fixing member being on a side wall of the hoistway wall and being arranged below the third vibration damping member.

34. The lift device according to claim 33 wherein the support assembly comprises:
a first bracket;
a second bracket arranged below the first bracket; and
wherein the upper end of the car guide rail extends into the first bracket and the first bracket and the second bracket have a same height.

35. The lift device according to claim 34 wherein the first bracket includes two transverse beams arranged in parallel and spaced apart in a horizontal direction, the transverse beams extending perpendicular to the side wall of the hoistway wall, wherein the second bracket includes two longitudinal beams arranged in parallel and spaced apart in a horizontal direction, the longitudinal beams extending perpendicular to the first bracket, and the upper end of the car guide rail is attached to the first bracket, and wherein the traction machine is mounted on the transverse beams and the transverse beams are positioned on opposite radial sides of a traction pulley of the traction machine.
